(19) United States
(12) Patent Application Publication
(10) Pub. No.: US 2014/0321533 A1
(43) Pub. Date: Oct. 30, 2014

(54) SINGLE-PATH VARIABLE BIT RATE VIDEO COMPRESSION

(71) Applicant: ATI TECHNOLOGIES ULC, Markham (CA)

(72) Inventor: Seyedeh Zahra Fatemian, Markham (CA)

(73) Assignee: ATI Technologies ULC, Markham (CA)

(21) Appl. No.: 13/872,359

(22) Filed: Apr. 29, 2013

(51) Int. Cl. H04N 19/172; H04N 19/503; H04N 19/124

(52) U.S. Cl. CPC H04N 19/00266; H04N 19/0009; H04N 19/00575
USPC 375/240.03

(57) ABSTRACT

Apparatuses, computer readable mediums, and methods of encoding video are disclosed. A video comprising a plurality of frames is encoded. The method may determine whether to encode a frame as an interframe (I frame) or a predicted frame (P frame). An I frame may be encoded with a quantization parameter (QP), which may be determined for the I frame. A P frame may be encoded with a QP limited to vary between a lower QP and an upper QP. After encoding N P frames, QP may be adjusted, where N is a fixed or dynamically adjusted number of frames. If a number of bits used to encode the N P frames exceeds a first budget threshold then the value of QP may be raised, and if the number of bits used to encode the N P frames is below a second budget threshold then the value of QP may be lowered.

### TECHNICAL FIELD

The disclosed embodiments are generally directed to encoding video, and in particular, to encoding video using single path variable bit rate video compression.

### BACKGROUND

Users of video capturing devices such as web cameras continue to capture more and more video. Often either the communication link that the video is being sent over or the file size where the video is being saved is limited. Additionally, encoders to compress video generated by applications such as web cameras cannot store the video and make multiple passes over the video to encode the video without incurring delays that may be unacceptable for the application. For example, a user waiting to view the video generated by a web camera may find it unacceptable to wait for the video to be compressed before being sent over the Internet.

Therefore, there is a need in the art for an apparatus, computer readable medium, and method of encoding video using single-path variable bit rate video compression.

### SUMMARY OF EMBODIMENTS

Some embodiments provide a method of encoding video using single-path variable bit rate compression. The method may include encoding a video comprising a plurality of frames. The method may include determining whether a frame is an interframe (I frame) or a predicted frame (P frame). The method may include encoding an I frame based on a bit budget. The method may include encoding a P frame with a quantization parameter (QP) limited to vary between a lower QP and an upper QP. The lower QP may be an average QP achieved to encode the I frame. The QP may initially be set to an average QP used to encode the I frame. The method may include adjusting QP after encoding N P frames, where N is a fixed or dynamically adjusted number of frames.

The method may include raising the value of the QP if a number of bits used to encode the N frames exceeds a first budget threshold. The method may include lowering the value of QP if the number of bits used to encode the N frames is below a second budget threshold. The method may include forcing a next frame of the plurality of frames to be an I frame, if the number of bits used to encode the N frames is below a third budget threshold.

Some embodiments provide an apparatus for encoding video comprising a plurality of frames. An example apparatus may include an encoder that may be configured to determine whether the frame is an I frame or a P frame. The encoder may be configured to encode an I frame based on a bit budget. The encoder may be configured to encode a P frame with a QP limited to vary between a lower QP and an upper QP. The lower QP may be an average QP achieved to encode the I frame. The QP may initially be set to an average QP used to encode the I frame. The encoder may be configured to adjust QP after encoding N P frames, where N is a fixed or dynamically adjusted number of frames. The encoder may be configured to raise the value of the QP, if a number of bits used to encode the N frames exceeds a first budget threshold. The encoder may be configured to lower the value of QP, if the number of bits used to encode the N frames is below a second budget threshold. The encoder may be configured to force a next frame of the plurality of frames to be an I frame, if the number of bits used to encode the N frames is below a third budget threshold.

Some embodiments provide a computer readable non-transitory medium including instructions which when executed in a processing system cause the processing system to execute a method for encoding a video comprising a plurality of frames according to a disclosed embodiment.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more disclosed embodiments may be implemented;

FIG. 2 is a schematic diagram illustrating an example of an encoder for single-path variable bit rate video compression, in accordance with some embodiments;

FIG. 3 is a schematic diagram illustrating an example of a method for single-path variable bit rate video compression, in accordance with some embodiments;

FIG. 4A is a schematic diagram illustrating bit frame sizes for a natural scene with a constant QP of 22;

FIG. 4B is a schematic diagram illustrating bit frame sizes for a synthetic scene with a constant QP of 22;

FIG. 4C is a schematic diagram illustrating bit frame size for a mixed scene with a constant QP of 16;

FIG. 5A schematically illustrates a quality of encoding with a constant bit rate (CBR) encoding of frames with scene change detection compared with constant quantization parameter (CQP);

FIG. 5B schematically illustrates a number of bytes used to encode frames for the CBR encoding illustrated in FIG. 5A;

FIG. 6A schematically illustrates a quality of encoding with a constant bit rate (CBR) encoding of frames with scene change detection compared with constant quantization parameter (CQP);

FIG. 6B schematically illustrates a number of bytes used to encode frames for the CBR encoding and the CQP illustrated in FIG. 5A;

FIGS. 7A, 7B, and 7C illustrate the operation of examples of the disclosed embodiments when content type is synthetic;

FIGS. 8A, 8B, and 8C illustrate the operation of examples of the disclosed embodiments when content type is synthetic;

FIGS. 9A, 9B, and 9C illustrate the operation of examples of the disclosed embodiments when content type is synthetic;

FIGS. 10A, 10B, and 10C illustrate the operation of examples of the disclosed embodiments when content type is mixed;

FIGS. 11A, 11B, and 11C illustrate the operation of examples of the disclosed embodiments when content type is mixed; and

FIGS. 12A, 12B, 12C, 12D, 12E, 12F, 12G, 12H, and 12I illustrate the operation of examples of the disclosed embodiments when content type is natural.

### DETAILED DESCRIPTION OF EMBODIMENT(S)

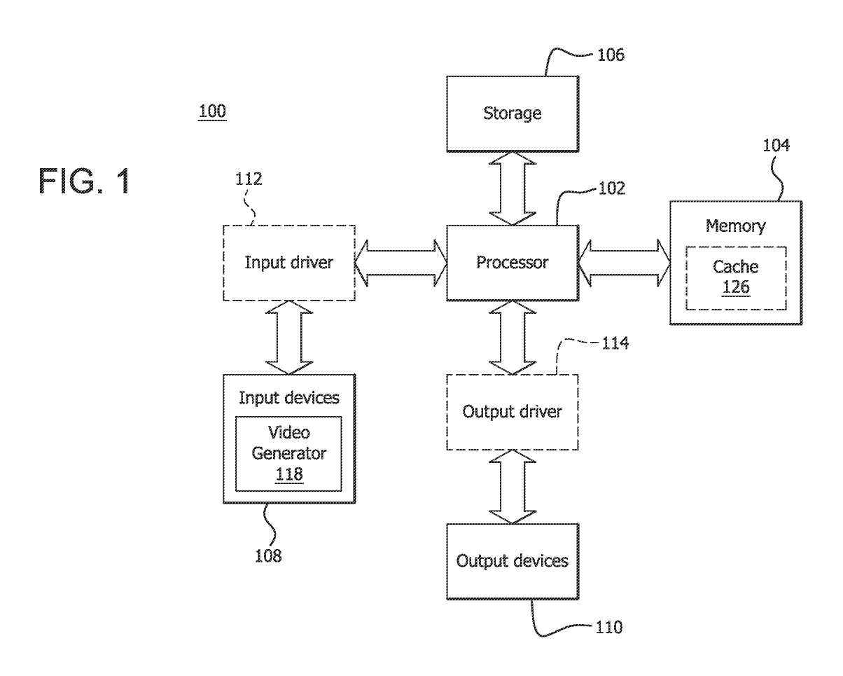

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The GPU may include two or more SIMD processing units. The memory 104 may be located on the same die as the processor 102, or may be located separately from the processor 102. The memory 104 may include a volatile or non-volatile memory, for example, random access memory (RAM), dynamic RAM (DRAM), or a cache. The memory 104 may include one or more memory controllers. The memory controller may be located on the same die as the CPU or another die.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The input devices 108 may include a video generator 118. Examples of a video generator 118 are a web camera and a video camera. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

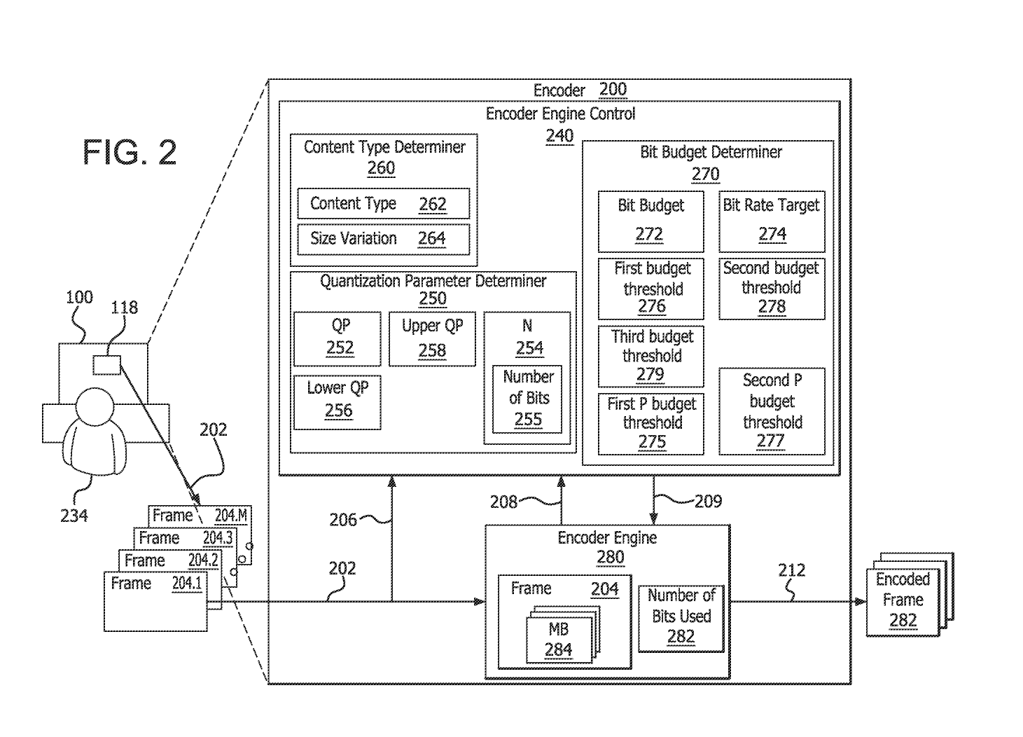

FIG. 2 is a schematic diagram illustrating an example of an apparatus for single-path variable bit rate video compression, in accordance with some embodiments.

Illustrated in FIG. 2 is a person 234, a computer 100, video 202, frames 204, an encoder 200, encoded video 212, and encoded frames 282. The web camera 118 generates the video 202 as a series of frames 204 and the encoder 200 encodes the video 202 into encoded video 212, which reduces the size of the encoded frames 282. The encoded video 212 may be sent to a receiver (not illustrated), over a communication network (not illustrated) such as the Internet.

The computer 100 includes a video camera 118, and the encoder 200. The video camera 118 generates the video 202, and may generate the video 202 as frames 204. In other embodiments, the video 202 may be generated from other sources such as video cameras, software programs that generate video, mobile telephones, tablets, or other sources that generate video.

The encoder 200 includes an encoder engine control 240 and an encoder engine 280. The encoder 200 may be located in the computer 100, or in another device 100. In some embodiments, the encoder 200 may be located across a communication network (not illustrated) from where the video 202 is generated. As illustrated, the encoder engine 280 includes a frame 204, which is being encoded, and a number of bits 282. The encoder engine 280 may be an encoder that receives frames 204 of the video 202 and parameters 209 from the encoder engine control 240 and returns encoding information 208 to the encoder engine control 240 and based on the parameters 209 encodes frames 204 of the video 202. The encoder engine 280 may take a frame 204 of video and split the frame 204 into macro blocks (MBs) 284. The number of bits used 282 may be a number of bits the encoder engine 280 has used to encode a frame 204. The number of bits used 282 may be a number of bits used to encode a frame 204 so far in a process of encoding the frame 204. For example, the number of bits used 282 may be a number of bits used to encode one or more MBs 284 of a frame 204, or the bits used to encode the entire frame 204. The encoding information 208 may include the number of bits used 282 and whether a frame 204 is being encoded as a P frame or an I frame. The parameters 209 may include a quantization parameter (QP) 252, and an indication of whether or not a frame 204 should be an I frame 204. The encoder 200 may take a frame 204 and divide it into blocks of pixels, and then convert the blocks of pixels into blocks of transform coefficients. The blocks of transform coefficients may be quantized based on the QP. A lower value of QP will often result in less compression with the number of bits used 282 being larger. A higher value of QP will often result in greater compression with the number of bits used 282 being smaller.

The encoder engine 280 may be compliant with an encoding standard such as H.264. The encoder engine 280 may encode a frame 204 as interframe (I frame), which may be a fully intact frame 204 which may be used to encode subsequent frames 204 by referring to portions of the I frame 204. The encoder engine 280 may encode some frames as predicted frames (P frames) 204, which may be encoded, at least partially, by referring back to an I frame 204. The encoding engine 280 may encode a frame with intra frame 204 references which are references to other portions of the same frame, or inter frame 204 references which are references to previous frames 204.

The encoder engine control 240 includes quantization parameter determiner 250, content type determiner 260, and bit budget determiner 270. The bit budget determiner 270 may include a bit budget 272, bit rate target 274, first budget threshold 276, second budget threshold 278, third budget threshold 279, first P budget threshold 275, and second P budget threshold 277. The bit budget determiner 270 may determine a bit budget 272 based on a bit rate target 274. The bit budget 272 may include a bit budget 272 for I frames and a bit budget 272 for P frames. The bit budget 272 may include a bit budget for a group of frames such as frames 204.1 to frame 204.m.

The bit rate target 274 may be a target bit rate such as 20 million bits per second for the encoded video 212. The bit budget determiner 270 may determine the bit budget 272 based at least partially on a content type 262. For example, the content type 262 may be initially set to natural. Based on this content type 262, the bit budget determiner 270 may determine that the bit budget 272 for I frames in the group 204.1 to 204.m should have bit budget 272 for I frame=to 4*bit budget 272 for P frames. The bit budget determiner 270 may raise the bit budget 272 for P frames when the content type 262 is determined to be synthetic.

The bit budget determiner 270 may determine a first budget threshold 276, a second budget threshold 276, a third budget threshold 279, a first P budget threshold 275, and a second P budget threshold 277, for the QP determiner 250 to use during encoding of a P frame 204, as discussed below.

The QP determiner 250 includes a QP 252, N 254, a lower QP and an upper QP. The QP determiner 250 may determine a QP 252 for an I frame 204 based on a determined bit budget 272 for the I frame 204. The QP determiner 250 may determine QP 252 based on a heuristic method for determining an estimated QP based on the bit budget 272. The encoder engine 280 may receive a frame 204. The encoder engine control 240 may then send the determined QP 252 for the I frames to the encoder engine 280 to encode the frame 204 as an I frame using QP 252.

The QP determiner 250 may be configured to set an initial QP 252 for P frames 204. The QP determiner 250 may be configured to receive a number of bits used 282 for encoding a portion of a P frame 204. The QP determiner 250 may be configured to adjust the QP 252 for the P frame 204 based on a number of bits used 282 to encode a portion of the P frame 204. The QP determiner 250 may permit QP 252 to vary between a lower QP 256 and an Upper QP 258 during the encoding of a P frame 204. By limiting the amount the QP 252 can vary within a P frame 204, the quality of the encoded video 212 may remain within a quality variance based on how much the QP 258 is permitted to vary. When the number of bits used 282 used to encode a portion of the P frame 204 exceeds a first P budget threshold 275, then more bits are being used to encode this P frame 204 then allocated by the bit budget 272 by a threshold value. The QP determiner 250 may adjust the QP 252 up so that fewer bits may be used to encode the remaining portion of the P frame 204. However, the quality of the remaining portion of the P frame 204 may be lower due to the increased quantization the encoder engine 280 will use based on the QP 252. When the number of bits used 282 used to encode a portion of the P frame 204 is below a second P budget threshold 277, then fewer bits are being used to encode this P frame 204 then allocated by the bit budget 272 by a threshold value. The QP determine 250 may adjust the QP 252 down so that more bits may be used to encode the remaining portion of the P frame 204. The quality of the remaining portion of the P frame 204 may be higher due to the decreased quantization the encoder engine 280 will use based on the QP 252.

The QP determiner 250 may be configured to adjust QP 252 for P frames 204 every N P frames 204. N may be a number of frames 204 that may be less than M, which may be the number of frames in a group of frames 204. The QP determiner 260 may be configured to keep track of the number of bits 255 used to encode N 254 frames. The QP determiner 260 may be configured to check every N frames if the number of bits 255 used to encode the N 254 frames 204 exceeds a first budget threshold 276, and if it does then raise the value of QP 252 for the next frame 204. If the number of bits 255 used to encode the N 254 frames 204 is below a second budget threshold 278 then lower the value of QP 252 for the next frame 204.

The QP determiner 250 may be configured to reset the value of QP 252 each time a new I frame 204 is encoded. The QP determiner 250 may be configured to reset the value of QP 252 each M frames 204 have been encoded. The bit budget determiner 270 may be configured to determine a new bit budget 272, bit rate target 274, first budget threshold 276, second budget threshold 278, third budget threshold 279, first P budget threshold 275, second P budget threshold 277, each M frames 204.

The content type determiner 260 includes a content type 262 and size variation 264. The content type determiner 260 may be configured to determine a content type of the video 202. The content type 262 may include natural, synthetic, and mixed. Examples of different types of content types 262 are provided below. The content type determiner 260 may be configured to initialize the content type 262 to natural. The content type determiner 260 may be configured to monitor the number of bits used 282 to encode frames 204 and to determine a content type based on a size variation 264 of the different frames 204. For examples, as disclosed below, a natural content type 262 needs a relatively fewer number of bits to encode the P frames 204 and a natural content type 262 has fewer scene changes. The content type determiner 260 may determine that frames 204 that have few scene changes and require a relatively fewer number of bits used 282 to encode the frames 204 may be a natural scene. The content type determiner 260 may determine that the content type is natural, if a difference between a number of bits to encode two successive frames of a series of P frames exceeds a first threshold less than a second threshold number of times. The first threshold and the second threshold may be determined experimentally based on the type of encryption and the types of video that is being encoded. The content type determine 260 may determine that the content type is synthetic, if a difference between a number of bits to encode two successive frames of a series of P frames exceeds a first threshold a second threshold number of times. The difference exceeding a first threshold a second threshold number of times would indicate that there are frequent scene changes where the difference between the scene changes is large.

The content type determiner 260 may determine that frames 204 that have more scene changes and require a higher number of bits used 282 to encode the frames 204 may be a synthetic content type 262. The content type determiner 260 may determine that frames 204 that have an intermediate number of scene changes and change between requiring a greater number of bits used 282 to encode P frames and a fewer number of bits used 282 to encode P frames may be a mixed scene type 262.

In some embodiments, the encoder 200 may be a single pass encoder 200 so that the video 202 is encoded once to generate the encoded video 212.

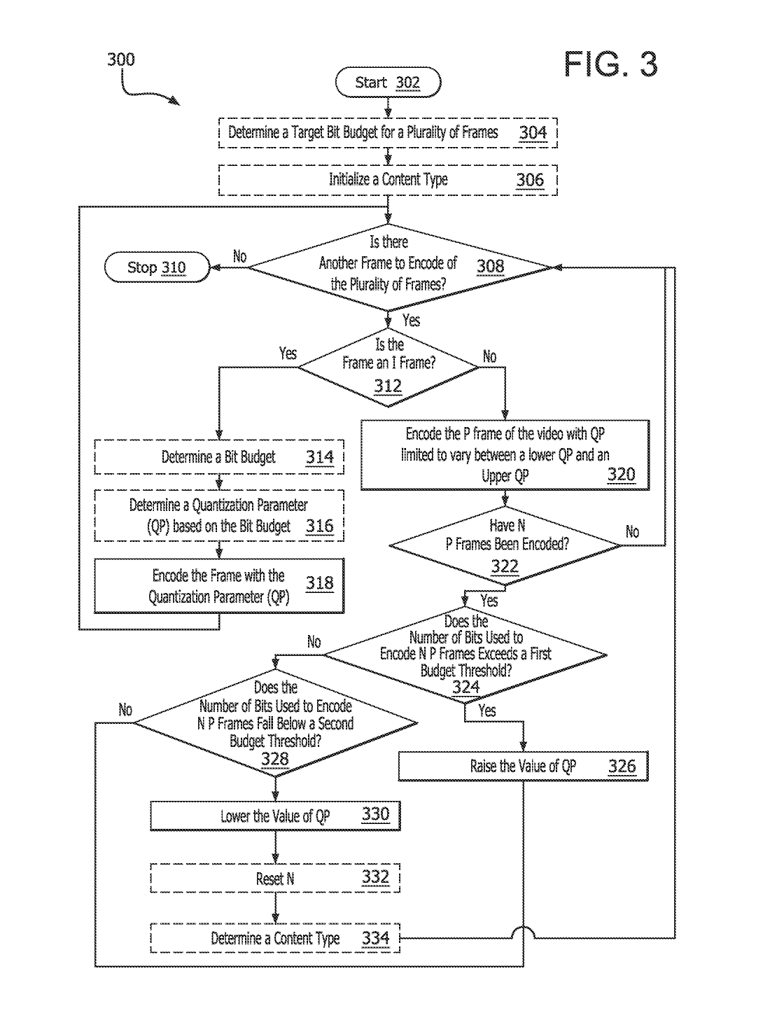

FIG. 3 is a schematic diagram illustrating an example of a method for single-path variable bit rate video compression, in accordance with some embodiments. The method 300 may begin with determine a target bit budget for a plurality of frames 304. For example, the bit budget determiner 270 may determine a bit budget 272 for the frames 204.1 to 204.m. The method 300 may continue with initialize a content type 306. For example, the content type determiner 260 may initialize the content type 262 as natural. The method 300 may continue with is there another frame to encode of the plurality of frames 308. For example, the encoder 200 may check to see if there is another frame of the frames 204.1 to 204.m to encode prior to re-determining the bit budget 272.

If there is not another frame to encode, then the method 300 may stop 310. If there is another frame to encode, then the method 300 may continue with is the frame an I frame 312. For example, the encode engine 280 may indicate to the encoder engine control 240 via the encoding information 208 that the frame currently being encoded is an I frame 204. Alternatively, or in addition, the encoder engine control 240 may indicate to the encoder engine 280 that the frame 204 should be an I frame via encoder parameters 209. If the frame is an I frame, then the method 300 continues with determine a bit budget 314. For example, the bit budget determiner 270 may determine a bit budget 272 for I frames. Optionally, the method 300 continues with determine a QP based on the bit budget 316. For example, the quantization parameter determiner 250 may determine QP 252 using a heuristic algorithm to determine QP 252 to meet the bit budget 272 for I frames. The method 300 may continue with encode the frame with the QP 318. For example, the encoder engine 280 may encode the frame 204 as an I frame with the QP 252 sent as an encoder parameter 209. During the encoding of the I frame the QP 252 may be adjusted to meet the bit budget 272. An average value of the QP 252 achieved in encoding the I frame may be determined. The method 300 continues with returning to 308.

Alternatively, if the frame is not an I frame at 312, then the method 300 continues with encode the P frame of the video with QP limited to vary between a lower QP and an upper QP 320. For example, the encoder engine control 240 may send the QP 252 to the encoder engine 280 as encoder parameters 209. The encoder engine 280 may then encode a portion of the frame 204 and send to the encoder engine control 240 the number of bit used 282 as encoder information 208. The quantization parameter determiner 250 may determine whether the number of bits used 282 exceeds a first P budget threshold 275, in which case the QP 252 would be raised and sent to the encoder engine 280 to use to encode another portion of the frame 204. The quantization parameter determiner 250 may determine whether the number of bits used 282 is lower than a second P budget threshold 277, in which case the QP 252 would be lowered and sent to the encoder engine 280 to use to encode another portion of the frame 204. This process may continue with the encoder engine 280 encoding another portion of the frame 204 and then sending the number of bits used 282 to the encoder engine control 240, which may then vary the QP 252 based on comparing the number of bits used with first P threshold 275 and second P budget threshold 277. In some embodiments, the quantization parameter determiner 250 may not lower or raise the QP 252 above or below upper QP 258, and lower QP 256, respectively, during the encoding of a P frame 204. In some embodiments, the lower QP is an average QP achieved to encode the I frame. In some embodiments, the QP 252 is initially set to an average QP used to encode the I frame.

The method 300 may continue with have N P frames been encoded 322. If N P frames have not been encoded then the method returns to 308. Otherwise, if N P frames have been encoded, then the method 300 continues with does the number of bits used to encode N P frames exceed a first budget threshold 324. For example, the quantization parameter determiner 250 may keep track of the number of bits 255 used to encode N p frames, determine if the number of bits 255 is greater than a first budget threshold 276. The method 300 may continue with raise the value of QP 326, if the number of bits used to encode N P frames exceeds a first budget threshold. For example, the quantization determiner 250 may raise the value of QP 252. If the number of bits used to encode N P frames does not exceed a first budget threshold, then the method 300 may continue with does the number of bits used to encode N P frames fall below a second budget threshold 328. For example, the quantization determiner 250 may determine whether or not the number of bits 255 used to encode N 254 P frames 204 is lower than a second budget threshold 278. If the number of bits 255 used to encode N 254 P frames 204 is lower than a second budget threshold, then the method continues with lower the value of QP 330. For example, the quantization determiner 250 may lower the value of QP 252. If the number of bits used to encode N P frames does not fall below a second budget threshold, then the method continues with reset N 332. For example, the quantization determiner may reset N 254.

The method 300 continues with determine a content type 334. For example, the content type determiner 260 may determine whether or not the size variation 264 indicates that the content type is natural, synthetic, or mixed. The method 300 may continue with returning to is there another frame to encode of the plurality of frames 308. The method 300 will stop 310 when there are not more frames of the plurality of frames to encode. The method 300 may be repeated for each plurality of frames of the video.

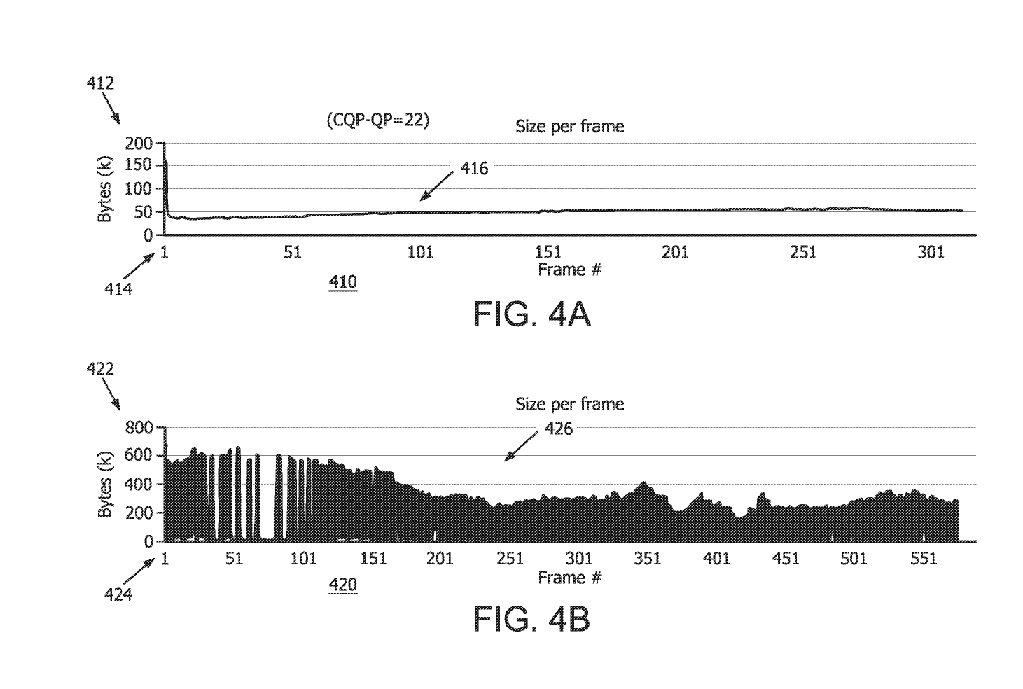

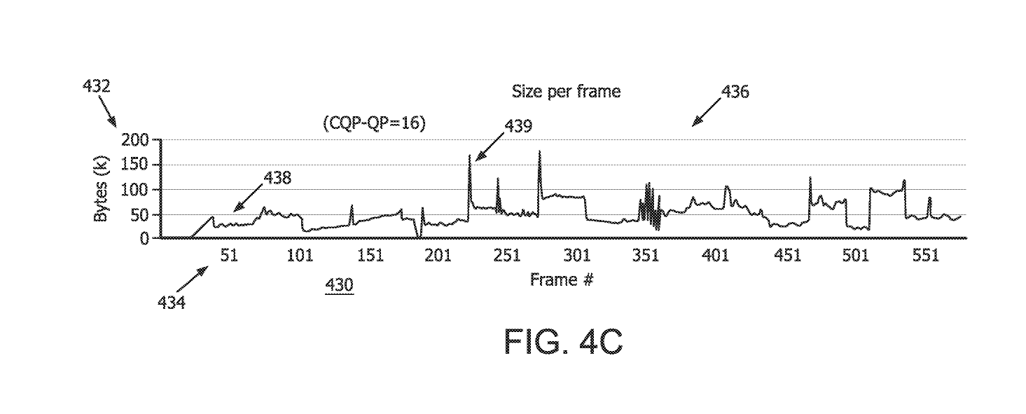

FIG. 4A is a schematic diagram illustrating bit frame sizes for a natural scene with a constant QP of 22. FIG. 4B is a schematic diagram illustrating bit frame sizes for a synthetic scene with a constant QP of 22. FIG. 4C is a schematic diagram illustrating bit frame size for a mixed scene with a constant QP of 16.

The number of bytes to encode a frame of the video is along the vertical axis 412, 422, 432, and the frame number is along the horizontal axis 414, 424, and 434. The graphs 416 illustrates how in natural scenes the number of bits to encode a frame is lower at approximately 50K bytes than the number of bits needed to encode a frame of a synthetic scene 426 at approximately 600K bytes to 200K bytes. The number of bits to encode a frame in natural scene 416 also varies less than in the synthetic scene 426. A natural scene may be a scene such as a video of a birthday party or a webcam video of a person talking. A synthetic scene may be the video generated by a video game where the scene changes and differences between successive frames tends to be greater. The number of bits needed to encode a mixed scene 436 tends to vary depending on whether the video frames are being generated by a natural source such as at 438 or whether the video frames are being generated by a synthetic source such as at 439.

The content type determiner 260 may be configured to determiner the content type 262 based on the differences between natural 410, synthetic 420, and mixed 430 scenes described above. Additionally, the bit budget determiner 270 may use the number of bits needed to encode the frames from the natural 410, synthetic 420, and mixed 430 scenes to determine the bit budget 272.

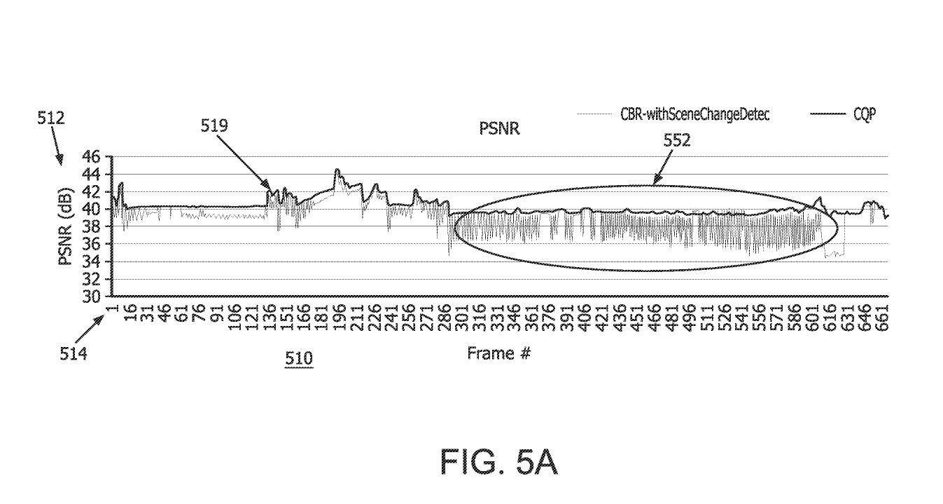

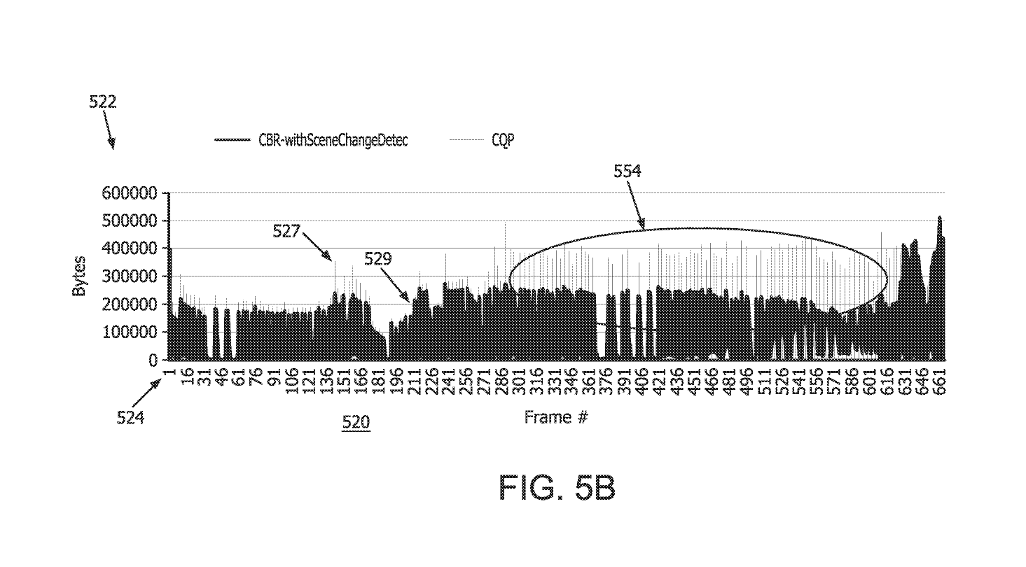

FIG. 5A schematically illustrates a quality of encoding with a constant bit rate (CBR) encoding of frames with scene change detection compared with constant quantization parameter (CQP.) The quality of a frame of the video is estimated on the vertical axis 512 with peak signal-to-noise ratio (PSNR). The frame number is along the horizontal axis 514. FIG. 5B schematically illustrates a number of bytes used to encode frames for the CBR encoding and the CQP illustrated in FIG. 5A. The number of bytes to encode a frame of the video is along the vertical axis 522 and the frame number is along the horizontal axis 524. The frame numbers in FIG. 5A correspond to the same frames in FIG. 5B.

The CQP 519, 529 provides a baseline in which the CBR with scene change detection 517, 527 can be measured. The CBR with scene change detection 517, 527 may not perform well when scene changes are missed. For example, the frames within 552, 554 illustrate that if scene changes are missed that the quality of the frames may be low. The CBR with scene change detection 517, 527 may be configured to detect scene changes when the number of MBs that are encoded with intra coding is high. The CBR with scene change detection 517, 527 may increase the bit budget when the number of MBs that are encoded with intra coding is high. When many MBs are skipped, the CBR with scene change detection 517, 527 may determine that the frames are static frames and decrease a bit budget. However, as illustrated in FIGS. 5A and 5B CBR with scene change detection 517, 527 suffers from a decrease in quality (PSNR) 512 when a scene change is not detected.

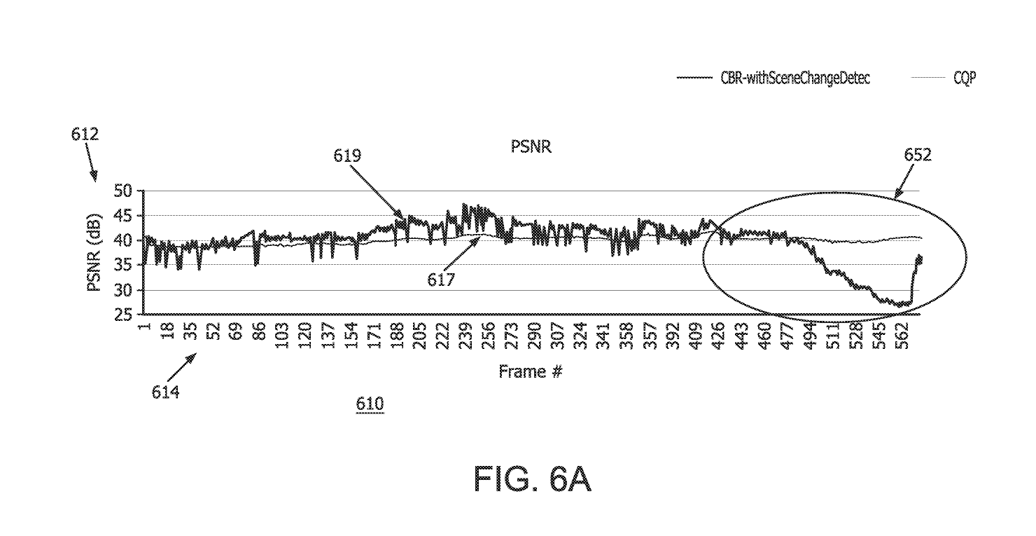

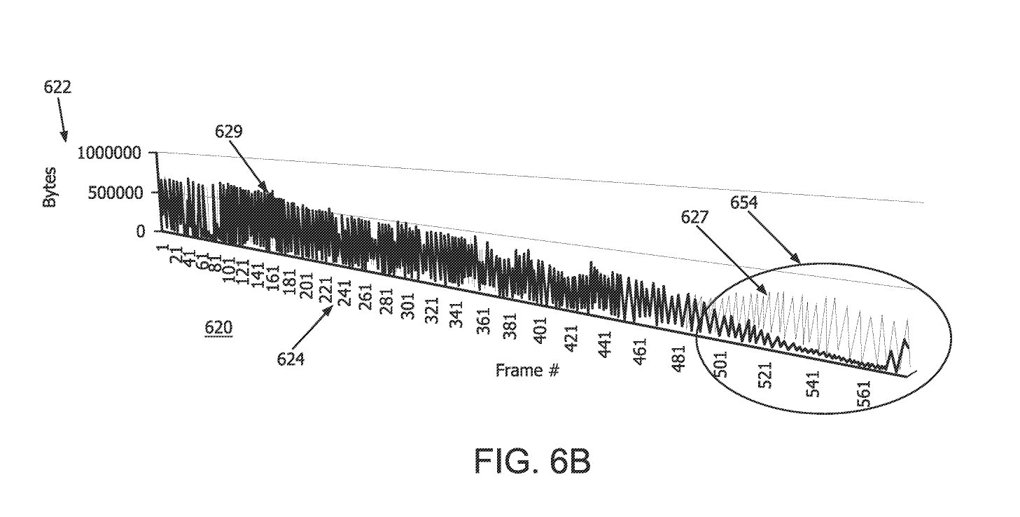

FIG. 6A schematically illustrates a quality of encoding with a constant bit rate (CBR) encoding of frames with scene change detection compared with constant quantization parameter (CQP.) The quality of a frame of the video is estimated on the vertical axis 612 with peak signal-to-noise ratio (PSNR). The frame number is along the horizontal axis 614. FIG. 6B schematically illustrates a number of bytes used to encode frames for the CBR encoding and the CQP illustrated in FIG. 6A. The number of bytes to encode a frame of the video is along the vertical axis 622 and the frame number is along the horizontal axis 624. The frame numbers in FIG. 6A correspond to the same frames in FIG. 6B.

The CQP 619, 629 provides a baseline in which the CBR with scene change detection 617, 627 can be measured. The CBR with scene change detection 617, 627 may not perform well when a bit budget runs low near the end of a group of frames. The group of frames may be frames 1 to 562, 614, 624. The bit rate may be a constraint due to a file size or bit rate of communication channel. The frames within 652, 654, illustrate that if bit budget is over used in the begging portion of a group of frames that the quality may suffer at the end of the group of frames 652, 654. The beginning portion of the group of frames illustrates that the CBR with scene change detection 617, 627 may have used too many bytes to encode frames of video. For example, between frame 100 and 200, CBR with scene change detection 617, 627 used more bytes per frame than the CQP 617, 627, but the quality of the resulted encoded frames was not significantly improved over the CQP 617, 627, as illustrated in FIG. 6A between frames 100 and 200. Additionally, FIGS. 6A and 6B illustrate that the quality may be dependent on the size of the group of frames. For example, in the example as illustrated if the budget had been based on a smaller group of frames, then the budget would have been reset prior to the frames within 652, 654, which may have improved the quality of the encoding of the frame within 652, 654.

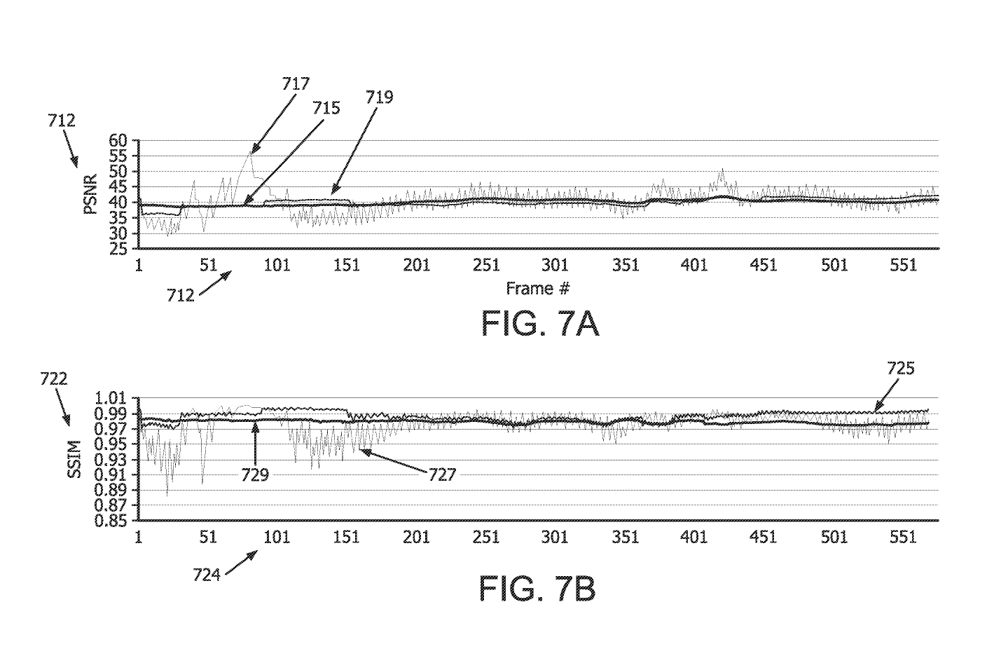

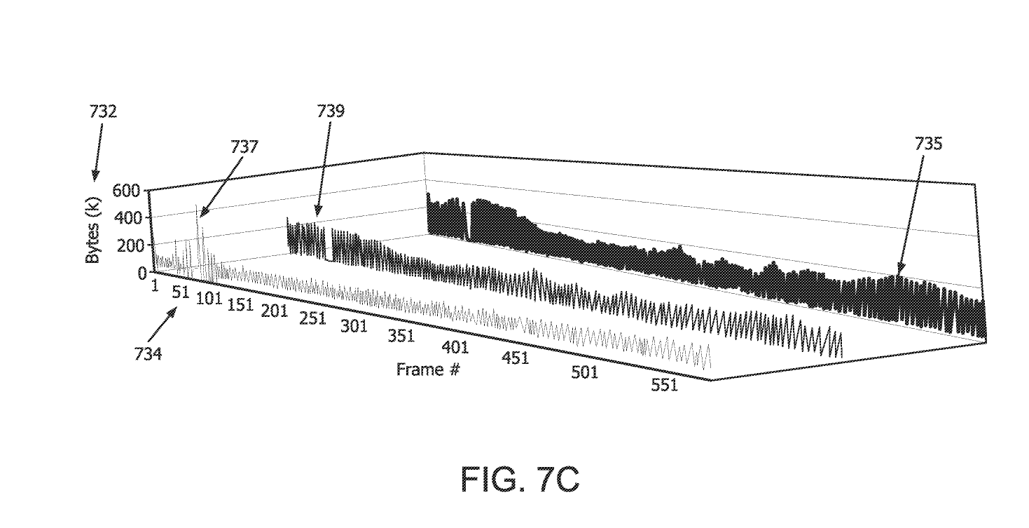

FIGS. 7A, 7B, and 7C illustrate the operation of examples of the disclosed embodiments when content type is synthetic. FIGS. 7A and 7B schematically illustrates a quality PSNR and structural similarity index (SSIM), respectively, of encoding with a constant bit rate (CBR), constant quantization parameter (CQP), and an embodiment of a single-path variable bit rate video compression encoder (VBR). FIG. 7C schematically illustrates a number of bytes used to encode frames for the CBR, the CQP, and VBR illustrated in FIGS. 7A and 7B.

The CQP 719, 729, 739 provides a baseline in which the CBR 717, 727, 737, and VBR 715, 725, 735, can be measured. The CBR in FIG. 7 is set at QP=20. The CBR in FIG. 7 is set at 50 megabytes per second (50 Mbps). The quality of the VBR 715, 725 performs well and is similar to the quality of the CQP 719, 729. The quality of the CBR 717, 727 fluctuates more. The CBR 717, 727 quality is very high around 50-100 frames and low from 100-150 frames.

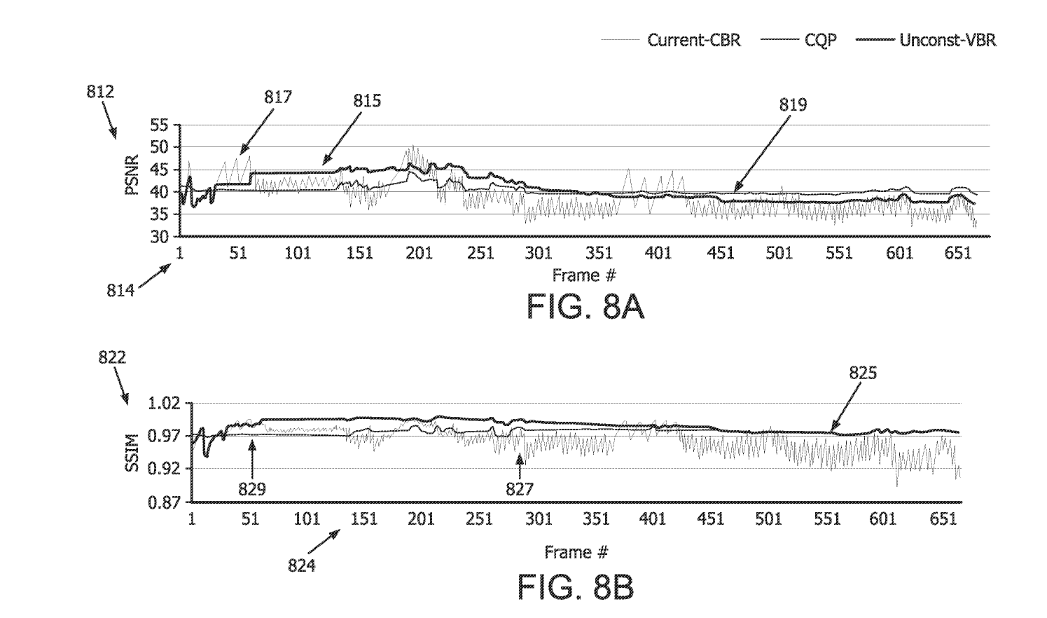

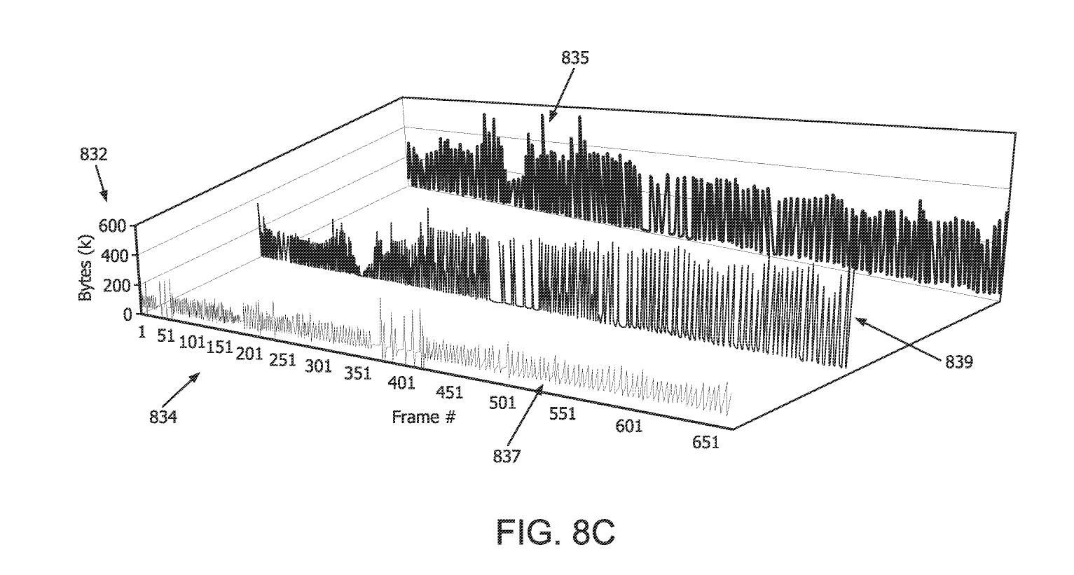

FIGS. 8A, 8B, and 8C illustrate the operation of examples of the disclosed embodiments when content type is synthetic. FIGS. 8A and 8B schematically illustrates a quality PSNR and structural similarity index (SSIM), respectively, of encoding with a constant bit rate (CBR), constant quantization parameter (CQP), and an embodiment of a single-path variable bit rate video compression encoder (VBR). FIG. 8C schematically illustrates a number of bytes used to encode frames for the CBR, the CQP, and VBR illustrated in FIGS. 8A and 8B.

The CQP 819, 829, 839 provides a baseline in which the CBR 817, 827, 837, and VBR 815, 825, 835, can be measured. The CBR in FIG. 8 is set at QP=22. The CBR in FIG. 8 is set at 20 mega bytes per second (20 Mbps). The scene type is synthetic and the frames were generated by a popular video game JustCause®. The quality of the VBR 815, 825 performs well and is similar to the quality of the CQP 819, 829. The quality of the CBR 817, 827 fluctuates more. The CBR 817, 827 quality is very high around 375-425 frames and low from 300-350 frames. The VBR 815 quality is a bit lower than the CQP 819 around frames 450 to 650, but the CQP 839 used many more frames to encode the frames 450 to 650 than VBR 835 as can be seen in FIG. 8C.

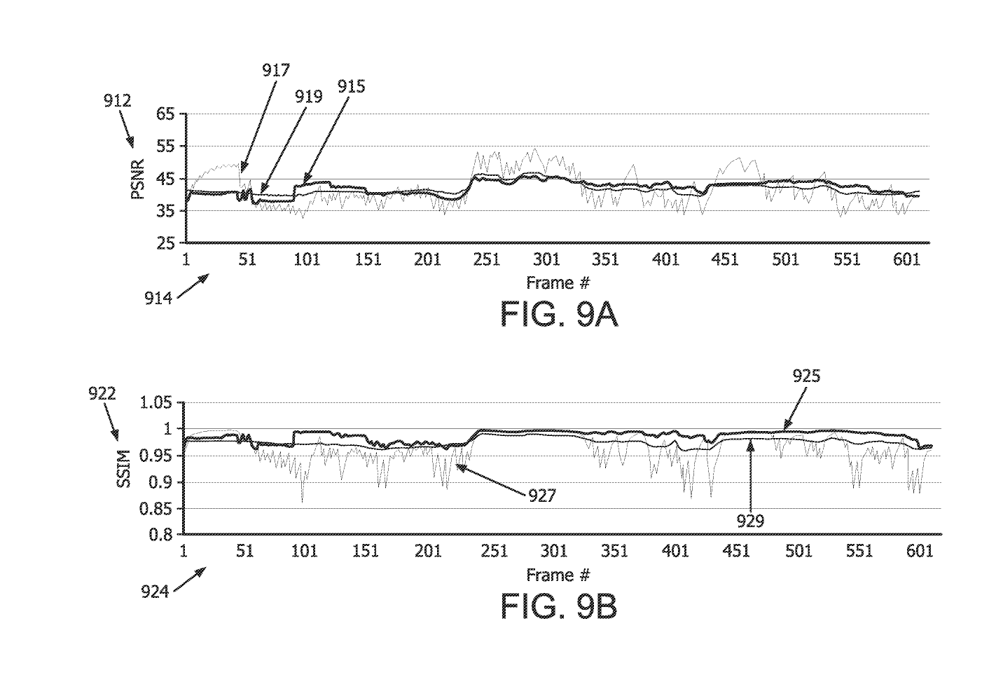

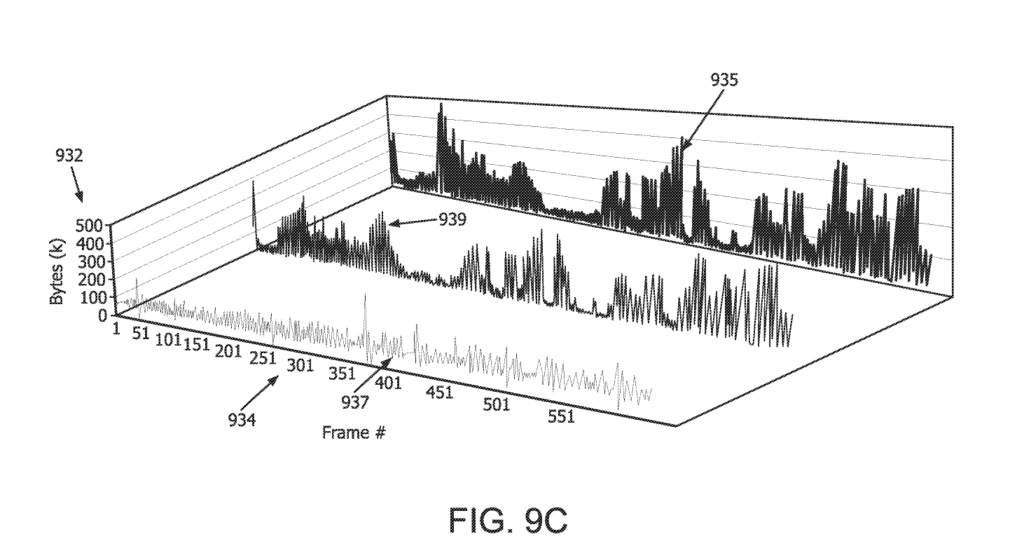

FIGS. 9A, 9B, and 9C illustrate the operation of examples of the disclosed embodiments when content type is synthetic. FIGS. 9A and 9B schematically illustrates a quality PSNR and structural similarity index (SSIM), respectively, of encoding with a constant bit rate (CBR), constant quantization parameter (CQP), and an embodiment of a single-path variable bit rate video compression encoder (VBR). FIG. 9C schematically illustrates a number of bytes used to encode frames for the CBR, the CQP, and VBR illustrated in FIGS. 9A and 9B.

The CQP 919, 929, 939 provides a baseline in which the CBR 917, 927, 937, and VBR 915, 925, 935, can be measured. The CBR in FIG. 9 is set at QP=22. The CBR in FIG. 9 is set at 20 mega bytes per second (20 Mbps). The scene type is synthetic and the frames were generated by a popular video game BlackOps®. The quality of the VBR 915, 925 performs well and is similar to the quality of the CQP 919, 929. The quality of the CBR 917, 927 fluctuates more. The CBR 917, 927 quality is very high around 300 frames and low around 100 frames. The VBR 915, 925 quality is a bit lower than the CQP 919, 929 around frame 75, but overall quality of the encoding of the VBR 915, 925 is higher and more consistent than either the CBR 917, 927 or the CQP 919, 929.

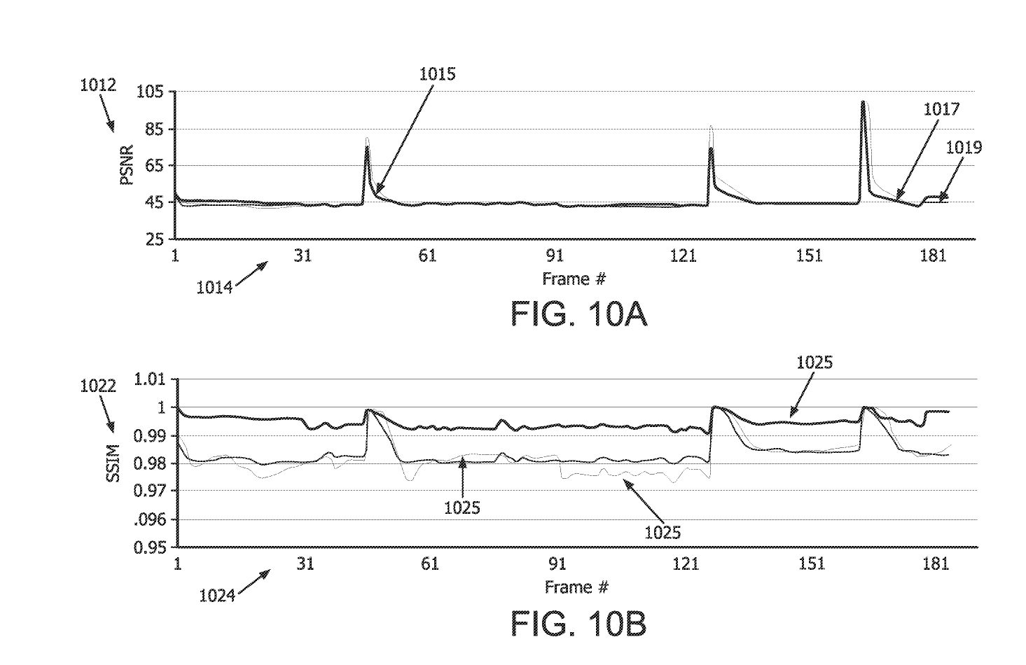

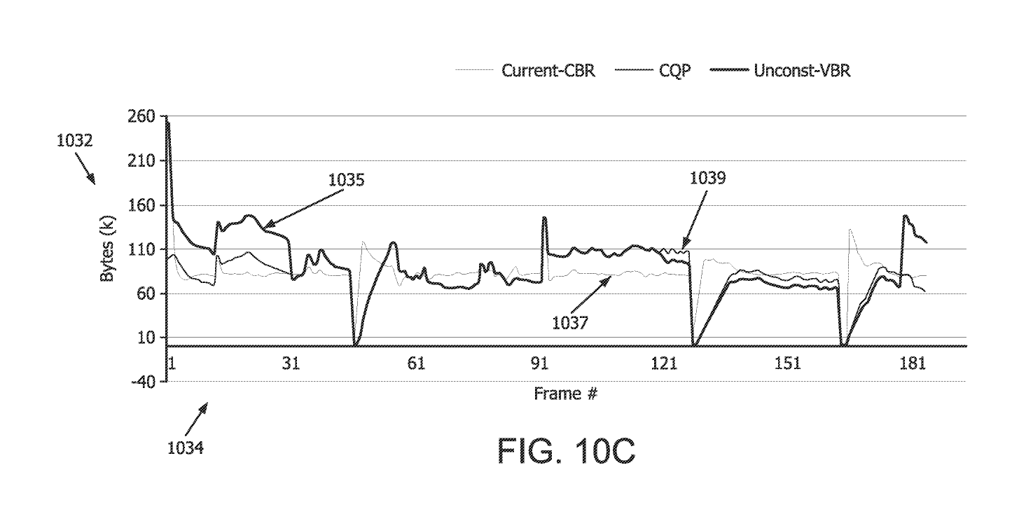

FIGS. 10A, 10B, and 10C illustrate the operation of examples of the disclosed embodiments when content type is mixed. FIGS. 10A and 10B schematically illustrates a quality PSNR and structural similarity index (SSIM), respectively, of encoding with a constant bit rate (CBR), constant quantization parameter (CQP), and an embodiment of a single-path variable bit rate video compression encoder (VBR). FIG. 10C schematically illustrates a number of bytes used to encode frames for the CBR, the CQP, and VBR illustrated in FIGS. 10A and 10B.

The CQP 1019, 1029, 1039 provides a baseline in which the CBR 1017, 1027, 1037, and VBR 1015, 1025, 1035, can be measured. The CBR in FIG. 10 is set at QP=22. The CBR in FIG. 10 is set at 20 mega bytes per second (20 Mbps). The scene type is mixed and the frames were generated by a popular video game Heavenly®. The quality of the VBR 1015, 1025 performs well and is similar to the quality of the CQP 1019, 1029. The quality of the CBR 1017, 1027 fluctuates more. The CBR 1017, 1027 quality is very high around 300 frames and low around 100 frames. The VBR 1015, 1025 quality is at least as good than the CQP 1019, 1029 and the CBR 1017, 1027.

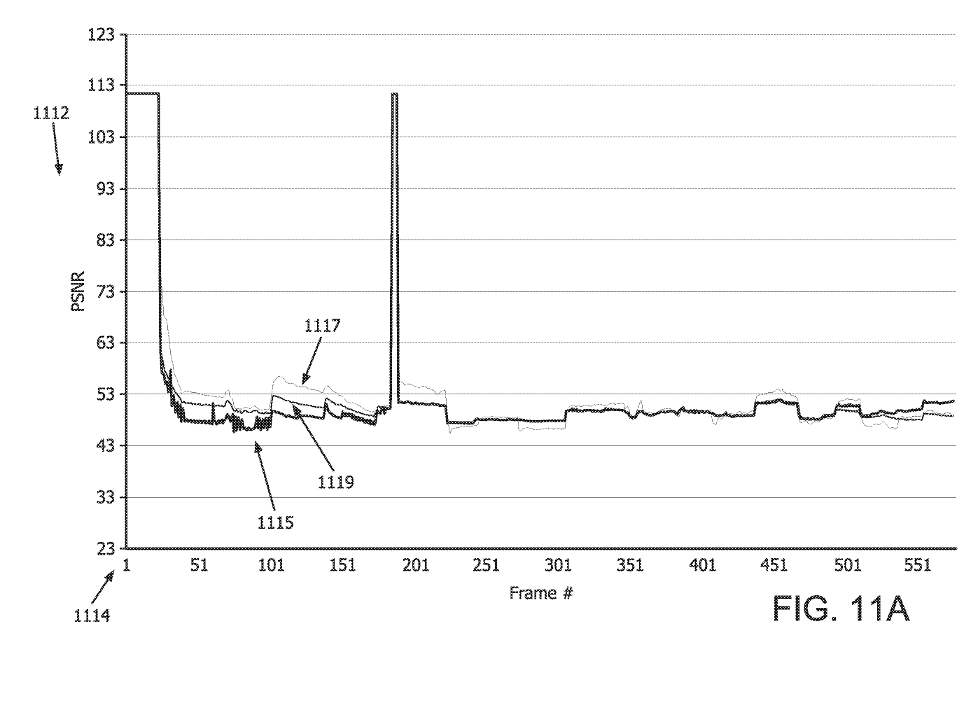

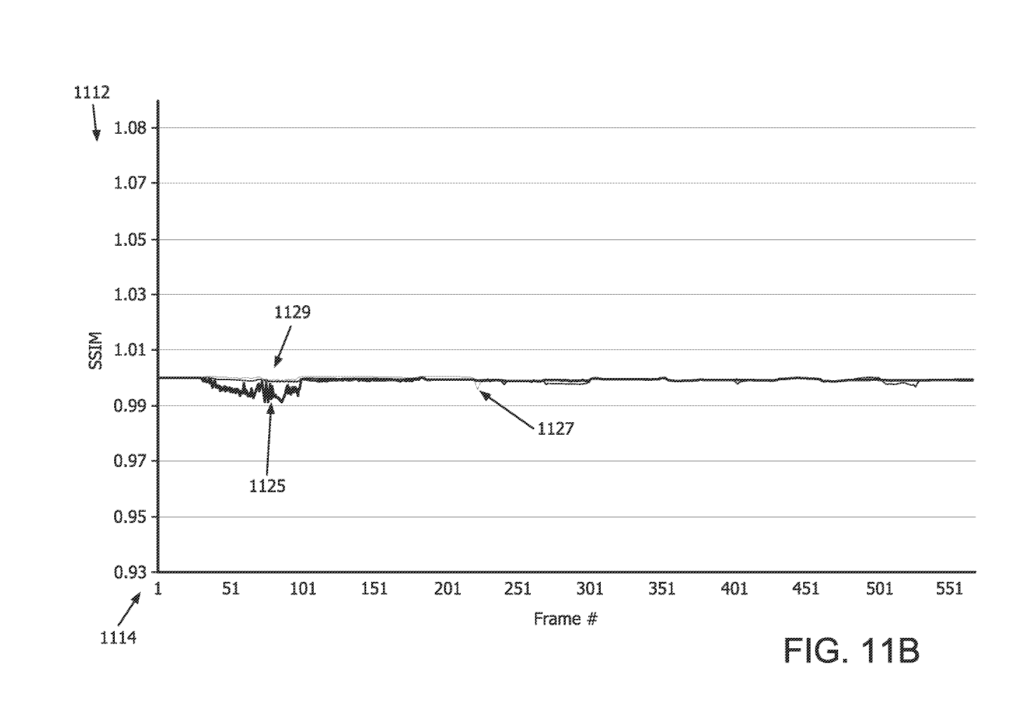

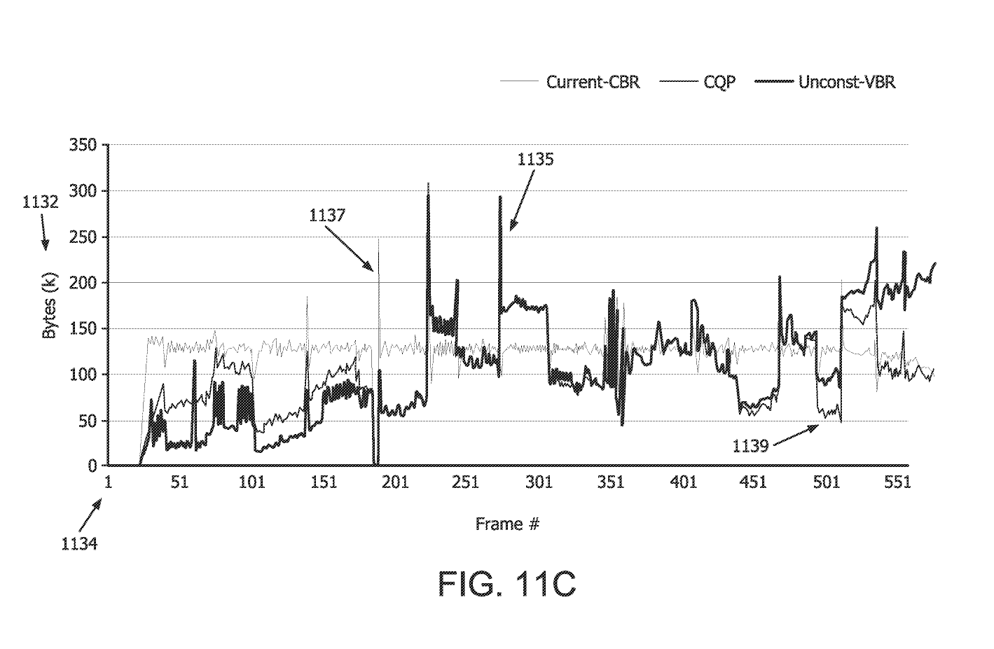

FIGS. 11A, 11B, and 11C illustrate the operation of examples of the disclosed embodiments when content type is mixed. FIGS. 11A and 11B schematically illustrates a quality PSNR and structural similarity index (SSIM), respectively, of encoding with a constant bit rate (CBR), constant quantization parameter (CQP), and an embodiment of a single-path variable bit rate video compression encoder (VBR). FIG. 11C schematically illustrates a number of bytes used to encode frames for the CBR, the CQP, and VBR illustrated in FIGS. 11A and 11B.

The CQP 1119, 1129, 1139 provides a baseline in which the CBR 1117, 1127, 1137, and VBR 1115, 1125, 1135, can be measured. The CBR in FIG. 11 is set at QP=16. The CBR in FIG. 11 is set at 25 mega bytes per second (25 Mbps). The scene type is mixed and the frames were generated by BBC® television. The quality of the VBR 1115, 1125, CQP 1119, 1129, and CBR 1117, 1127 is almost identical. The number of bytes to encode the frames is very similar for VBR 1135 and CQP 1139. The VBR 1135 used more frames near the end at about 500-551 due to the bit budget permitting more frames to be used so that the QP was lowered. The quality of CBR 1117, 1127 not dropping as it did in previous figures is due to the frames not needing as many bits to maintain a high quality encoding.

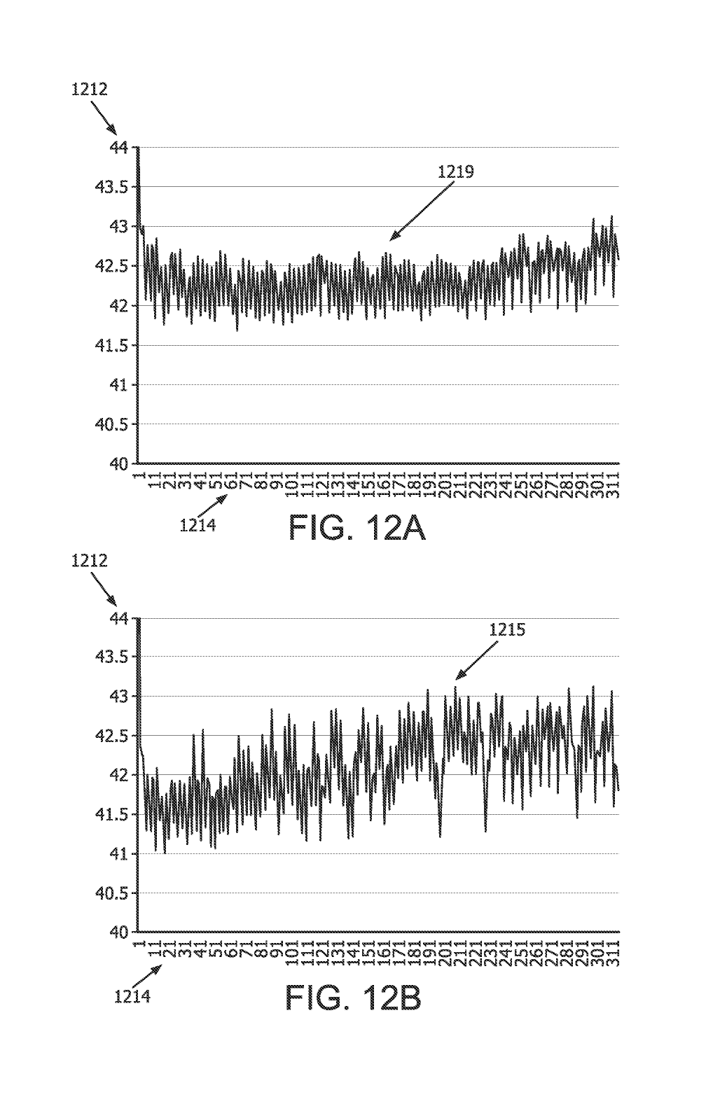

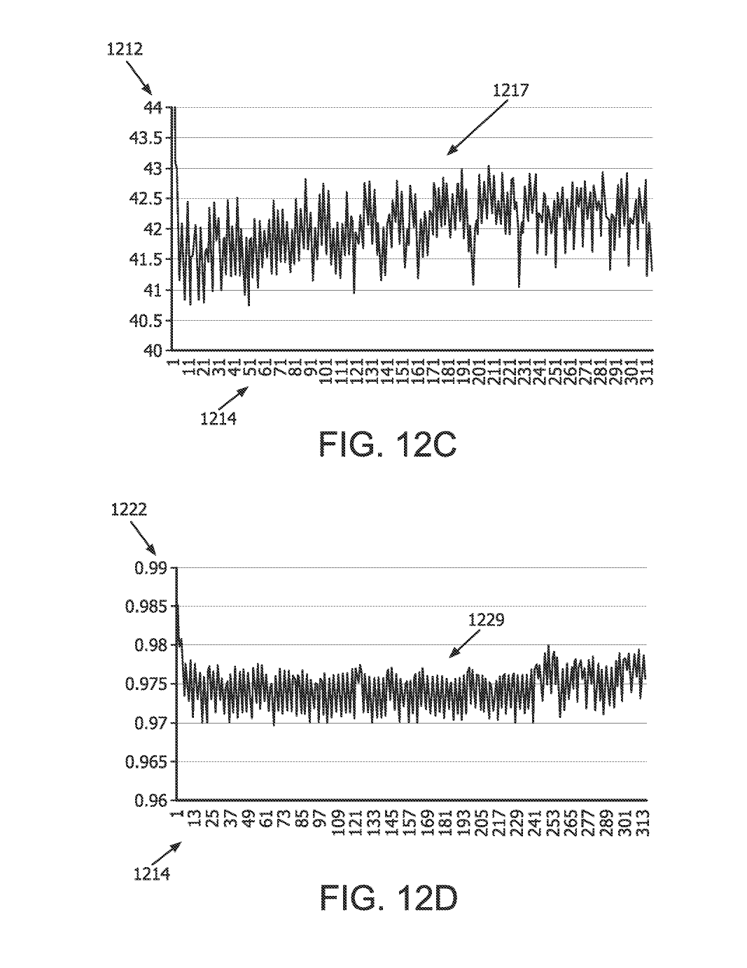

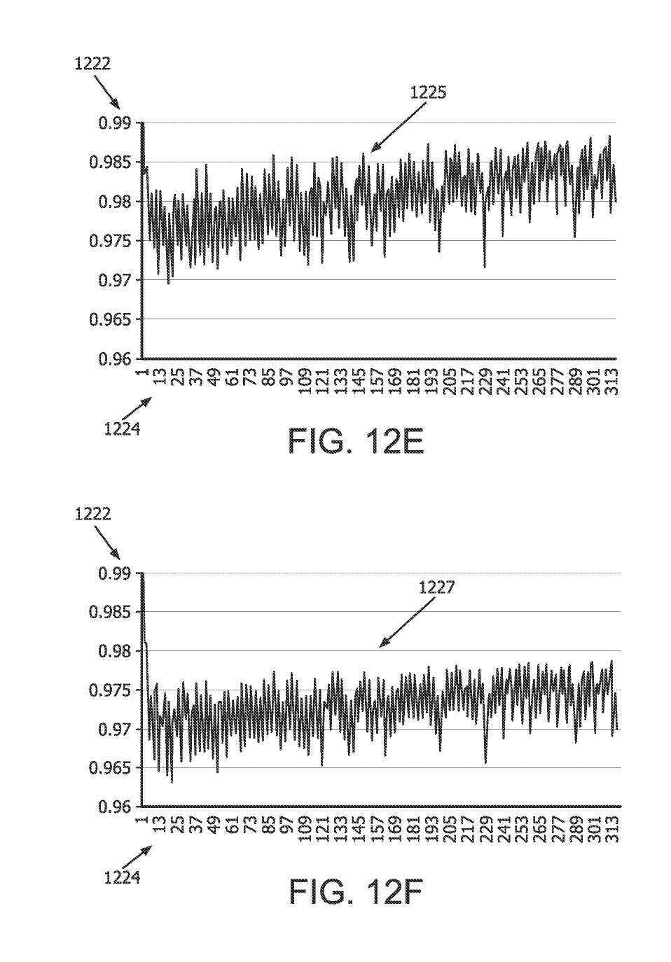

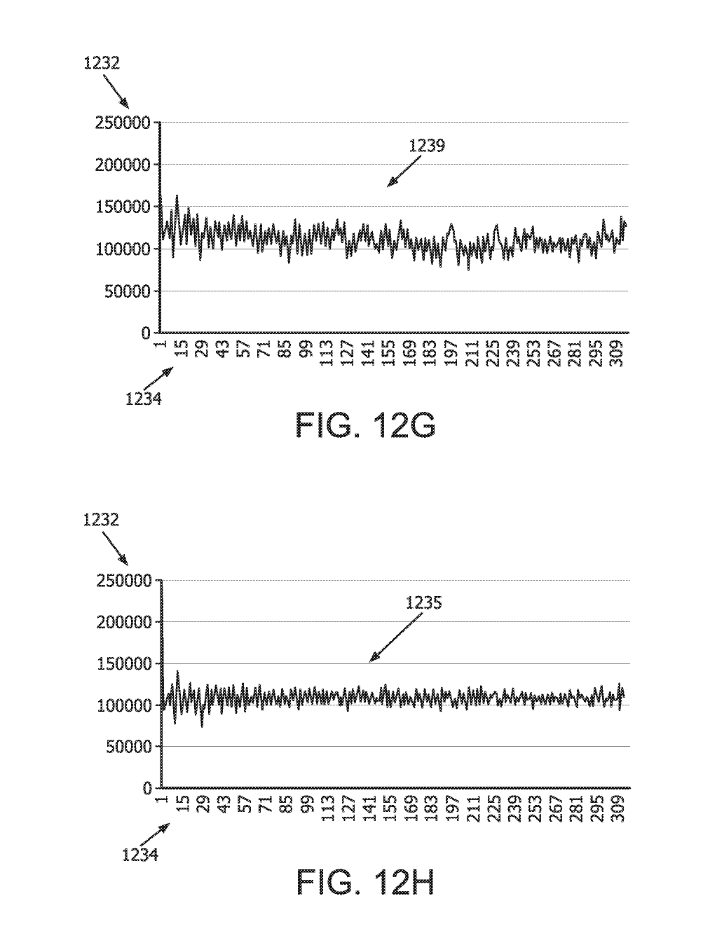

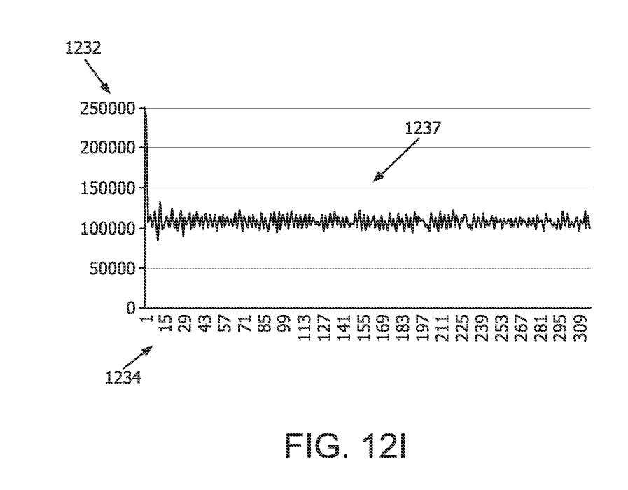

FIGS. 12A, 12B, 12C, 12D, 12E, 12F, 12G, 12H, and 12I illustrate the operation of examples of the disclosed embodiments when content type is natural. FIGS. 12A, 12B, and 12C schematically illustrate a quality PSNR of encoding with a constant bit rate (CBR), constant quantization parameter (CQP), and an embodiment of a single-path variable bit rate video compression encoder (VBR). FIGS. 12D, 12E, and 12F schematically illustrate structural similarity index (SSIM) of encoding with a constant bit rate (CBR), constant quantization parameter (CQP), and an embodiment of a single-path variable bit rate video compression encoder (VBR). FIGS. 12G, 12H, and 12I schematically illustrate a number of bytes used to encode frames for the CBR, the CQP, and VBR illustrated in FIGS. 12A and 12B.

The CQP 1219, 1229, 1239 provides a baseline in which the CBR 1217, 1227, 1237, and VBR 1215, 1225, 1235, can be measured. The CBR in FIG. 12 is set at QP=22. The CBR in FIG. 12 is set at 15 mega bytes per second (15 Mbps). The scene type is natural and the frames were generated by a webcam with a low amount of motion and a low amount of light. The quality of VBR 1215, CBR 1217, and CQP 1219, in FIG. 10A is similar. The quality of the VBR 1225 compared with CQP 1229 and CBR 1227 is consistently a bit higher in FIG. 10B. This is because in VBR 1225 the QP was raised because the bit budget was under budget. Additionally, CBR 1227 is less consistent and falls in frame 10-50 to levels that may be perceived by a person.

It should be understood that many variations are possible based on the disclosure herein. Although features and elements are described above in particular combinations, each feature or element may be used alone without the other features and elements or in various combinations with or without other features and elements.

Examples of the disclosed embodiments have the advantage that the quality within a frame does not vary greatly. Examples of the disclosed embodiments have the advantage that a combination of constant bit rate and constant quantization parameter is used that may include determining the bit budget based on the content type. Examples of the disclosed embodiments have the advantage that scene change detection methods are not relied on.

The methods provided may be implemented in a general purpose computer, a processor, or a processor core. Suitable processors include, by way of example, a general purpose processor, a graphics processing unit (GPU), a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the disclosed embodiments.

The methods or flow charts provided herein may be implemented in a computer program, software, or firmware incorporated in a computer-readable storage medium for execution by a general purpose computer or a processor. In some embodiments, the computer-readable storage medium is a non-transitory computer-readable storage medium. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method of encoding video comprising a plurality of frames, the method comprising:
if a frame of the plurality of frames is an interframe (I frame), then encoding the I frame based on a bit budget;
if the frame is a predicted frame (P frame), then encoding the P frame with a quantization parameter (QP) limited to vary between a lower QP and an upper QP, and adjusting QP after encoding N P frames according to: if a number of bits used to encode the N frames exceeds a first budget threshold then raising the value of the QP, and if the number of bits used to encode the N frames is below a second budget threshold then lowering the value of QP.

2. The method of claim 1, wherein the lower QP is an average QP achieved to encode the I frame.

3. The method of claim 1, wherein the QP is initially set to an average QP used to encode the I frame.

4. The method of claim 1, further comprises:
if the number of bits used to encode the N frames is below a third budget threshold then forcing a next frame of the plurality of frames to be an I frame.

5. The method of claim 1, wherein if the frame is the I frame, then encoding the frame based on a bit budget, further comprises:
determining the bit budget, wherein the first budget threshold and the second budget threshold are based on the bit budget.

6. The method of claim 5, wherein determining the bit budget further comprises:
determining the bit budget based at least on a content type.

7. The method of claim 6, further comprises:
determining that the content type is synthetic, if a difference between a number of bits to encode two successive frames of the N P frames exceeds a first threshold a second threshold number of times; and
determining that the content type is natural, if the difference between a number of bits to encode two successive frames of the N P frames exceeds the first threshold less than the second threshold number of times.

8. The method of claim 6, wherein the content type comprises one of: natural, synthetic, or mixed.

9. The method of claim 5, wherein determining the bit budget further comprises: determining the bit budget based on a bit rate target for the plurality of frames.

10. The method of claim 9, wherein the bit rate target is based at least on one of: a transmission rate of a communication connection or a target file size.

11. The method of claim 5, wherein encoding the frame with the QP limited to vary between a lower QP and an upper QP, further comprises:
splitting the frame into a plurality of macro blocks (MBs);
encoding one or more of the plurality of macro blocks (MBs); and
if a second number of bits used to encode the one or more of the plurality of MBs is greater than a first P threshold then adding one or more to QP so that QP is not over the upper QP, and if the second number of bits used to encode the one or more of the plurality of MBs is less than a second P threshold then lowering QP so that QP is not lower than an lower QP.

12. The method of claim 5, wherein determining the bit budget further comprises:
determining the bit budget based on a heuristic method for determining an estimated QP.

13. The method of claim 1, wherein encoding the frame of the plurality of frames, further comprises:
determining a content type based on a size variation of the number of bits used to encode different frames of the plurality of frames.

14. The method of claim 1, wherein encoding the I frame based on a bit budget comprises:
encoding the I frame based on the bit budget, wherein the I frame is encoded using a second QP, and wherein the second QP is determined to encode the I frame within the bit budget.

15. An apparatus for encoding video comprising a plurality of frames, the apparatus comprising:
an encoder configured to:
encode the frame based on a bit budget, if the frame is an interframe (I frame);
encode the frame with a QP limited to vary between a lower QP and an upper QP, if the frame is a predicted frame (P frame); and
adjust QP after encoding N P frames according to: if a number of bits used to encode the N frames exceeds a first budget threshold then raise the value of the QP, and if the number of bits used to encode the N frames is below a second budget threshold then lower the value of QP.

16. The apparatus of claim 15, wherein the lower QP is an average QP achieved to encode the I frame.

17. The apparatus of claim 15, wherein the QP is initially set to an average QP used to encode the I frame.

18. The apparatus of claim 15, further comprises:
if the number of bits used to encode the N frames is below a third budget threshold then forcing a next frame of the plurality of frames to be an I frame.

19. The apparatus of claim 15, wherein the decoder is further configured to:
determine the bit budget based at least on a content type.

20. A computer readable non-transitory medium including instructions which when executed in a processing system cause the processing system to execute a method for encoding a video comprising a plurality of frames, the method comprising the steps of:
encode the frame based on a bit budget, if the frame is an interframe (I frame);
encode the frame with the QP limited to vary between a lower QP and an upper QP, if the frame is a predicted frame (P frame);
and adjust QP after encoding N P frames according to: if a number of bits used to encode the N frames exceeds a first budget threshold then raise the value of the QP, and if the number of bits used to encode the N frames is below a second budget threshold then lower the value of QP.
